(19) United States
(12) Patent Application Publication
(10) Pub. No.: US 2014/0111525 A1
(43) Pub. Date: Apr. 24, 2014

(54) DISPLAY SYSTEM

(71) Applicant: JAPAN DISPLAY INC., Tokyo (JP)

(72) Inventors: Kazuhiro ODAKA, Tokyo (JP); Toshihiro SATO, Tokyo (JP)

(73) Assignee: JAPAN DISPLAY INC., Tokyo (JP)

(21) Appl. No.: 14/060,700

(22) Filed: Oct. 23, 2013

(30) Foreign Application Priority Data
Oct. 23, 2012 (JP) 2012-233423

(51) Int. Cl. G06T 1/60; G09G 3/32

(52) U.S. Cl. CPC G06T 1/60; G09G 3/3208
USPC 345/501; 345/77

(57) ABSTRACT

An image processing IC detects a fixed pattern displayed on the OEL panel within a period of time when a power supply is switched ON. A display position of the fixed pattern detected when the power supply is switched OFF is stored in a first memory, the display position of the fixed pattern stored in the first memory when the power supply is switched ON is read and sent to a driving circuit (DRV). The DRV measures element characteristics of a pixel at the display position of the fixed pattern sent from the image processing IC, compares with element characteristics of a pixel before deterioration stored in a second memory and sends a comparison result to the image processing IC. The image processing IC corrects image data input to the pixel at the display position of the fixed pattern based on the comparison result sent from the DRV.

### CROSS REFERENCE TO RELATED APPLICATIONS

This application is based upon and claims the benefit of priority from the prior Japanese Patent Application No.2012-233423, filed on 23 Oct. 2012, the entire contents of which are incorporated herein by reference.

### FIELD

The present invention is related to a display system including an organic EL display device and in particular, the present invention is related to an effective technology when reducing burn-in of an organic EL display panel.

### BACKGROUND

In recent years, the demand for flat display devices is increasing. Specifically, the development and practical application of organic EL displays devices which use organic EL (Electro Luminescence) elements (OLED: Organic Light Emitting Diode) which are light and thin and have excellent power consumption, video characteristics and viewing angles, are progressing. In an organic display panel of an organic EL display device, when a fixed pattern is displayed for long periods of time, the deterioration of the organic EL elements of the pixels which displays the fixed pattern progresses, and when organic EL elements deteriorate, the difference in the level of deterioration of the organic element reveals itself as a difference in luminosity even when the same image voltage is applied which is recognized in the case of displaying an image such as a high luminosity solid pattern (complete white screen display for example), otherwise known as burn-in.

A means for solving the above described problem is described in Patent Document 1 (Japanese Patent Application Laid-Open Publication No. 2006-091709). In Patent Document 1, a terminal voltage of an organic EL element is read out from a pixel of a selected row by a detection circuit within the pixel, the read out terminal voltage is stored in a storage device, corresponding pixel data is corrected according to the stored voltage and thereby luminosity unevenness caused by burn-in is prevented. However, in the means described in Patent Document 1 a detection circuit for each pixel is required and moreover, a dedicated storage device for performing correction is required which is a problem. The aim of the present invention is to solve the conventional technical problems described above by providing a technology which can reduce luminosity unevenness caused by burn-in without arranging a large memory on the organic EL display device side and thereby reducing the burden on the system side in a display system arranged with the organic EL display device. The aim described above and other aims and novel characteristics of the present invention will be made clear using the descriptions of the present specification and accompanying drawings.

### SUMMARY

A summary of a representative invention among the inventions disclosed by the present specification is explained as follows.

(1) A display system including an organic EL display panel including a plurality of pixels, an organic EL display device including a driving circuit; and a main body including an image processing circuit configured to supply display data to the organic EL display device, wherein the image processing circuit of the main body includes, a detection part configured to detect a fixed pattern displayed on the organic EL display panel within a period of time when a power supply of the organic EL display device is switched ON, a first memory configured to store a display position of the fixed pattern detected by the detection part when the power supply is switched OFF, a reading part configured to read the display position of the fixed pattern stored in the first memory and send the display position to the driving circuit, and a correction part configured to correct image data input to a pixel at the display position of the fixed pattern stored in the first memory based on a comparison results sent from the driving circuit of the organic EL display device, and wherein the driving circuit of the organic EL display device includes, a second memory configured to store element characteristics of a pixel of the organic EL display panel before deterioration, a measuring part configured to measure element characteristics of a pixel at the display position of the fixed pattern sent from the reading part of the main body, a comparison part configured to compare the element characteristics measured by the measuring part and the element characteristics stored in the second memory. And a sending part configured to send a comparison result of the comparison part to the main body.
(2) The detection part of the image processing circuit in (1) identifies as a fixed pattern when display data with half or more gradation of a maximum gradation is continuously input to each pixel of the organic EL display panel.
(3) The detection part of the image processing circuit in (2) identifies as a fixed pattern when display data with half or more gradation of a maximum gradation is continuously input for 10 or more frames to each pixel of the organic EL display panel.
(4) The element characteristics of the pixel in (1) are a power supply terminal voltage of each of the pixels.
(5) The measuring part of the driving circuit in (4) measures the power supply terminal voltage of each pixel when a resistor within the driving circuit converts a current flowing to a pixel at a display position of the fixed pattern to a voltage, the voltage being input to a first AD port, and by measuring a potential difference between the voltage input to the first AD port and a power supply voltage input to a second AD port.

### BRIEF DESCRIPTION OF DRAWINGS

FIG. 1 is a block diagram showing an approximate structure of a display system according to an embodiment of the present invention;

FIG. 2 is a circuit diagram showing an equivalent circuit of a pixel according to an organic EL display panel of an embodiment of the present invention;

FIG. 3 is a diagram showing an approximate structure of an organic EL display device according to an embodiment of the present invention;

FIG. 4 is a diagram showing an example of a display image displayed on the organic EL display panel of the organic EL display device;

FIG. 5 is a flowchart showing the process procedure of a burn-in reduction method according to an embodiment of the present invention; and

FIG. 6 is a diagram for explaining a method for measuring a power supply terminal voltage (Voled) of a pixel stored as fixed pattern data in an embodiment of the present invention.

### DESCRIPTION OF EMBODIMENTS

The embodiments of the present invention are explained in detail below while referring to the drawings. Furthermore, the same reference symbols are attached to components which perform the same function in all the drawings for explaining the embodiments, and therefore repeated explanations are omitted. In addition, the embodiments described herein should do not limit an interpretation of the scope of the patent claims of the present invention.

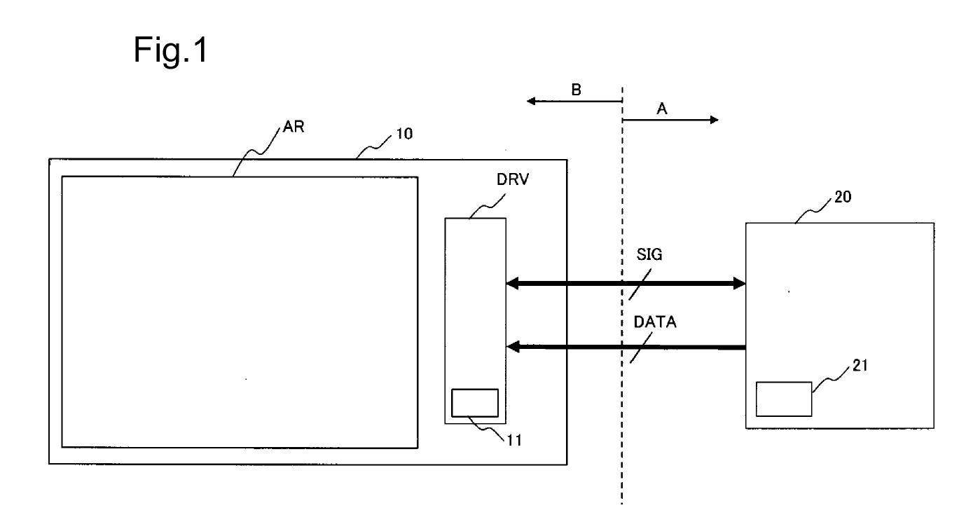

FIG. 1 is a block diagram showing an approximate structure of a display system according to an embodiment of the present invention. In FIG. 1, the part shown with the arrow A is the main body which includes an image processing IC (20). The interior of the image processing IC (20) includes a memory 21. In addition, in FIG. 1 the part shown by the arrow B is an organic EL display device 10 which is arranged with a driving circuit (DRV) formed by a driver IC. The interior of the driving circuit (DRV) includes a memory 11. Furthermore, the memory 11 within the driving circuit (DRV) may also be a transistor. In addition, AR indicated a display region of an organic EL display panel in FIG. 1. The organic EL display device 10 of the present embodiment is a small scale organic EL display device which is used in a smart phone or tablet for example.

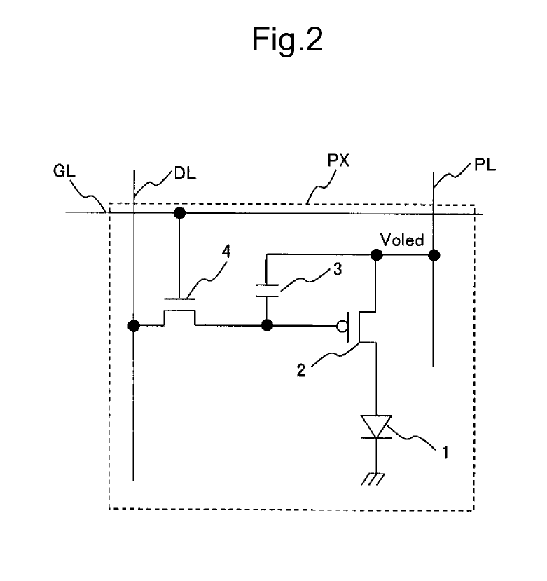

FIG. 2 is a circuit diagram which shows an equivalent circuit of a pixel in the organic EL display panel according to an embodiment of the present invention. The pixel (PX) shown in FIG. 2 is a pixel having the most general voltage programming method and an image line (DL), scanning line (GL) and power supply line (PL) are each input to the pixel (PX) respectively. An organic electro luminescence element (referred to as organic EL element herein) 1 is arranged as a light emitting element on each pixel (PX). A cathode electrode of the organic EL element 1 is connected to a common ground line and an anode of the organic EL element 1 is connected to a drain electrode of a p type thin film transistor (referred to as driver TFT herein) 2. A source electrode of the drive TFT 2 is connected to the power supply line (PL). Therefore, the source electrode of the organic EL element 1 can be called a power supply terminal supplied with a power supply voltage in each pixel (PX). In addition, a retaining capacitor 3 is connected between a gate electrode and the source electrode of the drive TFT 2. Furthermore, the gate electrode of the drive TFT 2 is connected the image line (DL) via a switching element 4 formed from an n type thin film transistor. A gate electrode of the switch element 3 is connected to the scanning line (GL). Here, the drive TFT 2 and switch element 4 are each formed on a glass substrate using a polycrystalline silicon thin film transistor using polycrystalline silicon in a semiconductor layer.

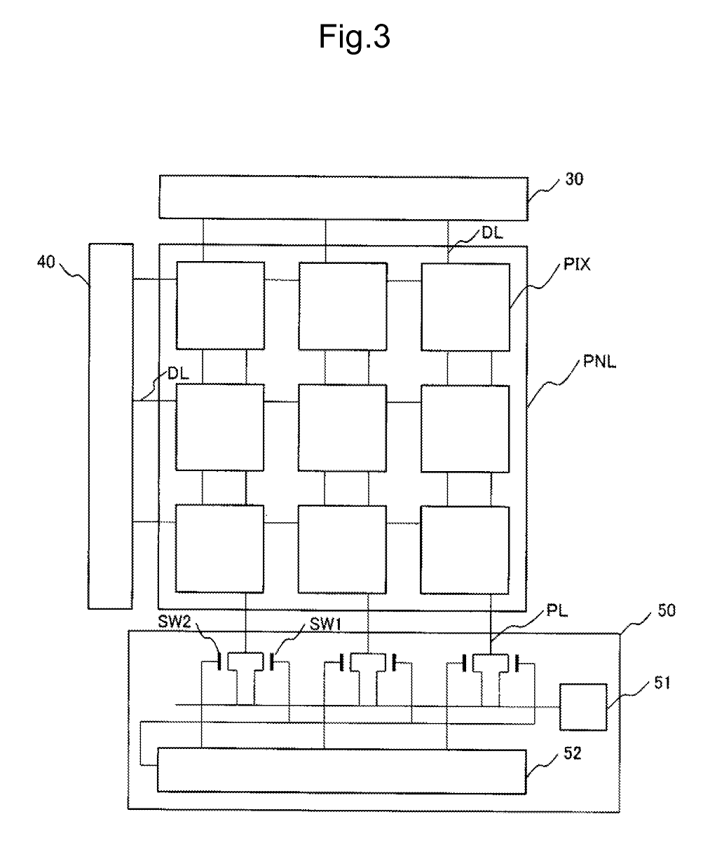

FIG. 3 is a diagram which shows an approximate structure of the organic EL display device according to an embodiment of the present invention. As is shown in FIG. 3, a plurality of pixels (PX) is arranged in a matrix shape in the organic EL display panel (PNL). Furthermore, although a plurality of pixels (PX) is actually arranged in the organic EL display panel (PNL), only nine pixels are described in FIG. 3. As described above, an image line (DL), scanning line (GL) and power supply line (PL) are each input to the pixel (PX) respectively. The scanning line (GL) is connected to a scanning line driving circuit 40. The scanning line driving circuit 40 supplies a driving voltage to the scanning line (GL) based on a control signal (SIG) supplied from the image processing IC (20) of the main body and selects a display line. The image line (DL) is connected to an image line driving circuit 30. The image line driving circuit 30 converts display data (DATA) supplied from the image processing IC (20) of the main body to an analog image voltage based on a control signal (SIG) supplied from the image processing IC (20) of the main body and supplies the voltage to the image line. The power supply line (PL) is connected to a power supply line driving circuit 50. The power supply line driving circuit 50 includes an OLED power supply circuit 51 and a scanning circuit 52. In a normal driving state, a switch element (SW1) formed from an n type MOS transistor is switched ON, a switch element (SW2) formed from a n type MOS transistor is switched OFF and a power supply voltage is supplied from the OLED power supply circuit 51 to all the power supply lines (PL). At the time of an initial process in which the organic EL display device 10 is deemed to be ON, the switch element (SW1) is switched OFF and the switch element (SW2) is subsequently switched ON and a power supply voltage is supplied in sequence to each power supply line (PL) from the OLED power supply circuit 51. Here, the image line driving circuit 30, scanning line driving circuit 40 and power supply driving circuit 50 may all be circuits arranged within the drive circuit (DRV). Alternatively, all or at least a part (for example, the scanning line driving circuit 40) of the image line driving circuit 30, scanning line driving circuit 40 and power supply driving circuit 50 may be formed on a glass substrate using a generally well known low temperature polycrystalline silicon thin film the same as the pixel (PX).

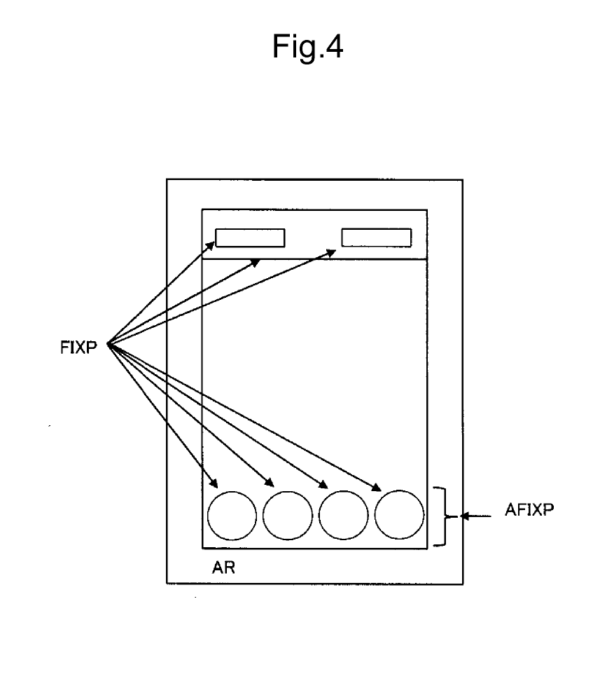

FIG. 4 is a diagram which shows an example of a display image displayed on the organic EL display panel of the organic EL display device. In FIG. 4, FIXP is a fixed pattern and AFIXP is a fixed pattern display region. Generally, the fixed pattern (FIXP) shown in FIG. 4 is displayed for a long period of time. However, when the fixed pattern (FIXP) as shown in FIG. 4 is displayed for a long period of time on the organic EL display panel, deterioration of the organic EL element 1 which displays the fixed pattern (FIXP) progresses. In addition, as described above, when the organic EL element 1 deteriorates, the difference in the level of deterioration of the organic element reveals itself as a difference in luminosity even when the same image voltage is applied which is recognized in the case of displaying an image such as a high luminosity beta pattern, otherwise known as the problem “burn-in”. The present embodiment reduces the above described burn-in which is caused by a fixed pattern displayed for long periods of time by calculating which display pattern is displayed for a long time using the image processing IC (20) of the main body, and identifying the fixed pattern from this result.

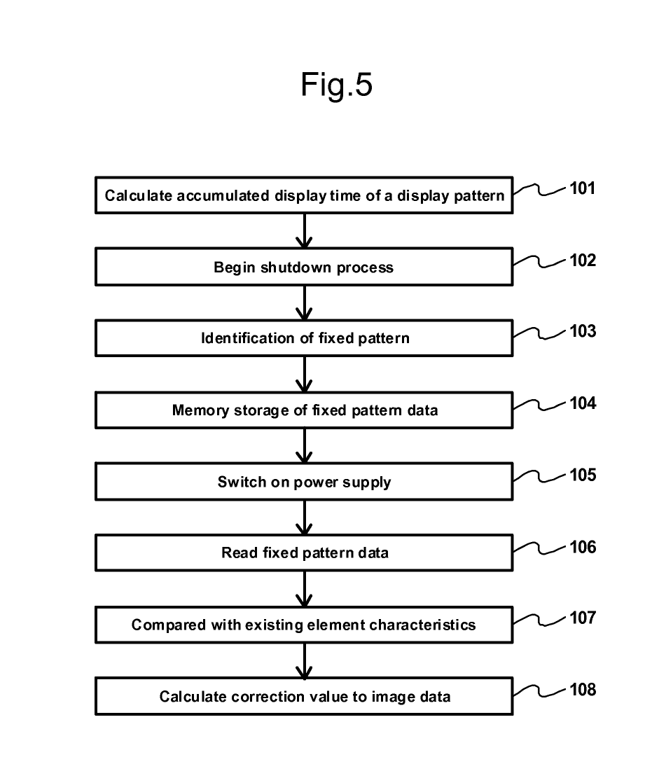

FIG. 5 is a flowchart which shows the process procedure of a method for reducing burn-in in an embodiment of the present invention. The method for reducing burn-in in the present embodiment is explained below. First, the cumulative display time of a display pattern is calculated in the image processing IC (20) of the main body (step 101). Next, at the time of a shutdown process (step 102), the image processing IC (20) of the main body identifies a fixed pattern display for a long period of time (step S103), and stores this data as fixed pattern data in a memory 21 (step S104). In steps S101˜S104, during normal operation the image processing IC (20) of the main body identifies a fixed pattern by calculating which pattern is displayed for a long period of time within one display period (when a switch of the organic EL display device is switched on from a standby ON until OFF). Specifically, display data supplied to each pixel is observed, pixels which are continuously supplied (a period of a several tens of frames for example) with half or more gradation display data of a maximum gradation are calculated and these pixels are identified as fixed pattern pixels and stored in memory 21. Next, when the power supply of the organic EL display device is switched ON (step S105), the image processing IC (20) of the main body reads the fixed pattern data from the memory 21 and sends the data to the driving circuit (DRV) of the organic EL display device 10 (step S106). Next, the driving circuit (DRV) of the organic EL display device 10 measures a power supply terminal voltage (Voled) of pixels stored as fixed pattern data, a difference with element characteristics stored in advance in the memory 21 is calculated and the calculation result is sent to the image processing IC (20) of the main body (step S107). Next, the image processing IC (20) of the main body determines to what extent burn-in has occurred from the calculation result sent from the driving circuit (DRV) and calculates a correction value of display data supplied to the organic EL element 1 of a pixel stored as fixed pattern data. This correction value is stored in the memory 21 of the main body (step S108).

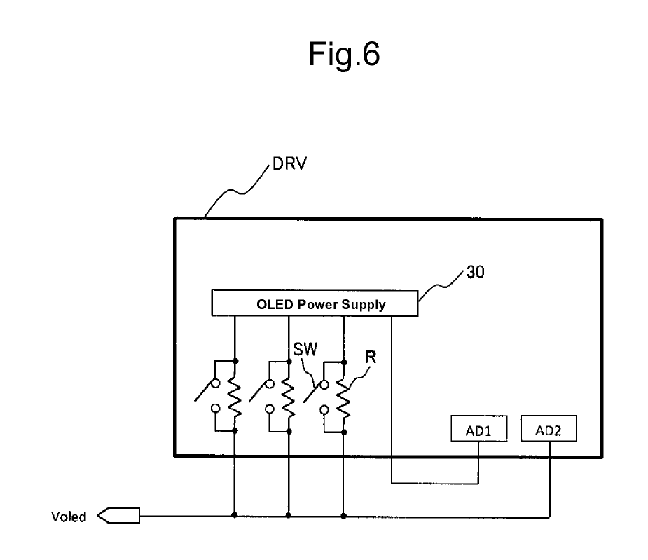

Steps S106-S108 are performed by an initial process when the power supply on switched on. During normal driving operation, burn-in is corrected by adding or subtracting the correction value stored in the memory 21 at the time of an initial process to or from the display data of a pixel of fixed pattern data stored in the memory 21 at the time of a shutdown process. The scanning line driving circuit 40 selects display lines in sequence in a state where an image voltage of a specific color (white for example) is supplied to each image line from the image line driving circuit 30 and the scanning circuit 52 supplies a power supply voltage to each pixel in sequence and thereby measurement of a power supply terminal voltage (Voled) to a pixel stored as fixed pattern data in step S107 is performed. Furthermore, the element characteristics stored in advance in memory 11 are also a result of measuring the power supply terminal voltage (Voled) of a pixel before deterioration under the same conditions as the conditions described above. Current which flows to the organic EL element 1 of each pixel (PX) is converted to a voltage by a resistor (R) within the driving circuit (DEV) when a switch element (SW) is switched OFF and the power supply terminal voltage (Voled) is measured by calculating a difference between a voltage input to AD2 port and a power supply voltage input to AD1 port and output from the OLED power supply circuit 51. Furthermore, during normal operation, the switch element (SW) is switched ON and the power supply voltage output from the OLED power supply circuit 51 is supplied to each power supply line (PL). In addition, FIG. 6 is a diagram for explaining a method for measuring a power supply terminal voltage (Voled) of a pixel stored as fixed pattern data in an embodiment of the present invention. In step 5106 and S107 described above, during an initial process when the power supply is switched on, the driving circuit (DRV) may measure the power supply terminal voltage (Voted) of all of the pixels, calculate a difference with the element characteristics stored in advance in the memory 11 and send the calculation result to the image processing IC (20) of the main body. The image processing IC (20) of the main body may read the fixed pattern data from the memory 21, select only the calculation result corresponding to the read fixed pattern data from among the calculation results sent from the driving circuit (DRV) and determine to what extent burn-in has occurred.

Based on this type of operation, the image processing IC (20) includes the following functions; a detection part which detects a fixed pattern displayed on the organic EL display panel, a reading part which reads the display position of a fixed pattern stored in a first memory and sends the position to a driving circuit, a correction part which corrects image data input to a pixel at the display position of a fixed pattern stored in the first memory based on a comparison result sent from the driving circuit, a first memory which stores the display position of a fixed pattern detected by the detection part and a second memory which stores element characteristics of a pixel of the organic EL display panel before deterioration. The driving circuit (DRV) includes the following functions; a measuring part which measures the element characteristics of a pixel at the display position of the fixed pattern sent from the reading part of the main body. A comparison part which compares the element characteristics measured by the measuring part and element characteristics stored in the second memory and a sending part which sends the comparison result of the comparison part to the main body.

As explained above, it is possible to obtain the following effects using the present embodiment.

(1) During a shutdown process a pattern which is displayed for a long period of time on an organic EL display panel is stored in the memory 21 as fixed pattern data, element characteristics of a pixel which displays the fixed pattern and element characteristics stored in advance in memory 11 are compared and the display data is corrected from the presence or not of a rise in voltage. Although a large capacity memory is required in the case where a detection process is performed on all pixels, it is possible to significantly reduce memory since only a partial detection process is performed on the displayed fixed pattern. Since only fixed pattern data is stored in the already existing memory 21 on the main body side, it is also possible to reduce the burden on the processes of the main body.
(2) The timing of correcting burn-in is during an initial process when a power supply is switched on, and by detecting a fixed pattern during a shutdown process and including a correction during an initial process it is possible to reduce the process burden on the main body side during normal driving operation. In addition, since normal operation is merely an accumulation process of a display pattern, it is possible to reduce power consumption used in fixed pattern detection and correction to a minimum. Although the invention performed by the inventors is explained here in detail based on the embodiments described above, the present invention should not be interpreted as being limited to the embodiments disclosed in this specification and various modifications can be made without departing from the scope of the invention.

According to the present invention it is possible to reduce luminosity unevenness caused by burn-in without arranged a large memory on the organic EL display device side and thereby reduce the burden on the system side.

What is claimed is:

1. A display system comprising:
an organic EL display panel including a plurality of pixels;
an organic EL display device including a driving circuit; and
a main body including an image processing circuit configured to supply display data to the organic EL display device;
wherein the image processing circuit of the main body includes;
a detection part configured to detect a fixed pattern displayed on the organic EL display panel within a period of time when a power supply of the organic EL display device is switched ON;
a first memory configured to store a display position of the fixed pattern detected by the detection part when the power supply is switched OFF;
a reading part configured to read the display position of the fixed pattern stored in the first memory and send the display position to the driving circuit; and
a correction part configured to correct image data input to a pixel at the display position of the fixed pattern stored in the first memory based on a comparison results sent from the driving circuit of the organic EL display device;
and wherein the driving circuit of the organic EL display device includes;
a second memory configured to store element characteristics of a pixel of the organic EL display panel before deterioration;
a measuring part configured to measure element characteristics of a pixel at the display position of the fixed pattern sent from the reading part of the main body;
a comparison part configured to compare the element characteristics measured by the measuring part and the element characteristics stored in the second memory; and
a sending part configured to send a comparison result of the comparison part to the main body.

2. The display system according to claim 1, wherein the detection part of the image processing circuit identifies as a fixed pattern when display data with half or more gradation of a maximum gradation is continuously input to each pixel of the organic EL display panel.

3. The display system according to claim 2, wherein the detection part of the image processing circuit identifies as a fixed pattern when display data with half or more gradation of a maximum gradation is continuously input for 10 or more frames to each pixel of the organic EL display panel.

4. The display system according to claim 1, wherein the element characteristics of the pixel is a power supply terminal voltage of each of the pixels.

5. The display system according to claim 4, wherein the measuring part of the driving circuit measures the power supply terminal voltage of each pixel when a resistor within the driving circuit converts a current flowing to a pixel at a display position of the fixed pattern to a voltage, the voltage being input to a first AD port, and by measuring a potential difference between the voltage input to the first AD port and a power supply voltage input to a second AD port.
